(19) United States
(12) Patent Application Publication
(10) Pub. No.: US 2013/0155017 A1
(43) Pub. Date: Jun. 20, 2013

(54) SYSTEM AND METHOD FOR A CLICKABLE INPUT DEVICE

(71) Applicant: SYNAPTICS INCORPORATED, Santa Clara, CA (US)

(72) Inventors: Chris Rehn, Neihu (TW); Su-Chuan Chiu, Neihu (TW); Yi-Yun Chang, Neihu (TW); Wei-Lung Lee, Neihu (TW)

(73) Assignee: SYNAPTICS INCORPORATED, Santa Clara, CA (US)

(21) Appl. No.: 13/717,171

(22) Filed: Dec. 17, 2012

Related U.S. Application Data
(60) Provisional application No. 61/576,882, filed on Dec. 16, 2011.
(60) Provisional application No. 61/602,498, filed on Feb. 23, 2012.

(51) Int. Cl. G06F 3/041; G06F 3/044

(52) U.S. Cl. CPC G06F 3/0414; G06F 3/044
USPC 345/174

(57) ABSTRACT

An input device includes a capacitive sensing device including a plurality of sensor electrodes disposed on a substrate, the capacitive sensing device having an edge region, a support structure, and a separation device coupled to the support structure and the capacitive sensing device. The separation device is configured to allow non-uniform displacement of the capacitive sensing device and activation of a button in response to a force applied to the capacitive sensing device by a user. The separation device includes a first flexure mechanism coupled to a first portion of the edge region of the capacitive sensing device, and a second flexure mechanism coupled to a second portion of the edge region of the capacitive sensing device, the first portion being remote from the second portion.

### CROSS-REFERENCE TO RELATED APPLICATIONS

This application claims the benefit of U.S. Prov. Pat. No. 61/576,882, filed Dec. 16, 2011, and U.S. Prov. Pat. No. 61/602,498, filed Feb. 28, 2012. The contents of the foregoing provisional patent applications are hereby incorporated by reference.

### FIELD OF THE INVENTION

This invention generally relates to electronic devices, and more specifically relates to sensor devices.

### BACKGROUND OF THE INVENTION

Input devices including proximity sensor devices (also commonly called touchpads, position sensing devices, or touch sensor devices) are widely used in a variety of electronic systems. A proximity sensor device typically includes a sensing region, often demarked by a surface, in which the proximity sensor device determines the presence, location and/or motion of one or more input objects. Proximity sensor devices may be used to provide interfaces for the electronic system. For example, proximity sensor devices are often used as input devices for larger computing systems (such as opaque touchpads integrated in, or peripheral to, notebook or desktop computers).

Some proximity sensor devices are configured to actuate one or more buttons (e.g., the equivalent of mouse buttons) when the device is subjected to a sufficient force. There continues to be a need for improved clickable input devices. For example, there is a need for clickable input devices that are thin (i.e., exhibit a low profile) and which can respond to an applied force in a way that depends upon the position of that force.

### BRIEF SUMMARY OF THE INVENTION

An input device in accordance with one embodiment includes a capacitive sensing device comprising a plurality of sensor electrodes disposed on a substrate, the capacitive sensing device having an edge region, a support structure, and a separation device coupled to the support structure and the capacitive sensing device. The separation device is configured to allow non-uniform displacement of the capacitive sensing device and activation of a button in response to a force applied to the capacitive sensing device by a user. The separation device comprises a first flexure mechanism coupled to a first portion of the edge region of the capacitive sensing device, and a second flexure mechanism coupled to a second portion of the edge region of the capacitive sensing device, the first portion being remote from the second portion.

A separation device in accordance with one embodiment is configured to be positioned between a support structure and a capacitive sensing device of an input device having a button component provided therein. The separation device comprises: a first flexure mechanism coupled to a first portion of an edge region of the capacitive sensing device, and a second flexure mechanism coupled to a second portion of the edge region of the capacitive sensing device, the first portion being remote from the second portion. The first flexure mechanism and second flexure mechanism are configured to allow non-uniform displacement of the capacitive sensing device and activation of the button component in response to a force applied to the capacitive sensing device by a user.

### BRIEF DESCRIPTION OF DRAWINGS

The present invention will hereinafter be described in conjunction with the appended drawings, where like designations denote like elements, and:

FIG. 1 is a block diagram of an example system that includes an input device in accordance with an embodiment of the invention;

FIG. 2 is a conceptual block diagram depicting an example electrode pattern;

FIGS. 3A and 3B are a top view and a cross-sectional view, respectively, of an example clickable input device;

FIGS. 4A-4C depict operation of the clickable input device illustrated in FIG. 4B;

FIGS. 5A and 5B depict operation of a clickable input device in accordance with one embodiment;

FIG. 6 depicts an example clickable input device configuration;

FIG. 7 depicts an example clickable input device configuration;

FIG. 8 depicts an example clickable input device configuration; and

FIG. 9 is a conceptual cross-sectional representation of a clickable input device in accordance with one embodiment.

### DETAILED DESCRIPTION OF THE INVENTION

The following detailed description presents a number of example embodiments and is not intended to limit the invention or the application and uses of the invention. Furthermore, there is no intention to be bound by any expressed or implied theory presented in the preceding technical field, background, brief summary, or the following detailed description.

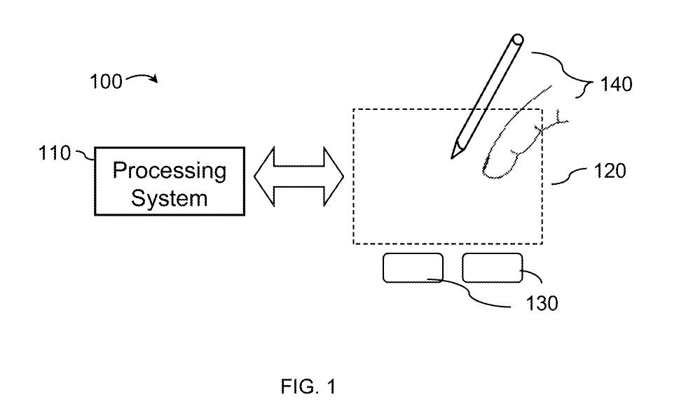

Various embodiments of the present invention provide input devices and methods that facilitate improved usability. FIG. 1 is a block diagram of an example input device 100, in accordance with embodiments of the invention. The input device 100 may be configured to provide input to an electronic system (not shown). As used in this document, the term “electronic system” (or “electronic device”) broadly refers to any system capable of electronically processing information. Some non-limiting examples of electronic systems include personal computers of all sizes and shapes, such as desktop computers, laptop computers, netbook computers, tablets, web browsers, e-book readers, and personal digital assistants (PDAs). Additional example electronic systems include composite input devices, such as physical keyboards that include input device 100 and separate joysticks or key switches. Further example electronic systems include peripherals such as data input devices (including remote controls and mice), and data output devices (including display screens and printers). Other examples include remote terminals, kiosks, and video game machines (e.g., video game consoles, portable gaming devices, and the like). Other examples include communication devices (including cellular phones, such as smart phones), and media devices (including recorders, editors, and players such as televisions, set-top boxes, music players, digital photo frames, and digital cameras). Additionally, the electronic system could be a host or a slave to the input device.

The input device 100 can be implemented as a physical part of the electronic system, or can be physically separate from the electronic system. As appropriate, the input device 100 may communicate with parts of the electronic system using any one or more of the following: buses, networks, and other wired or wireless interconnections. Examples include I²C, SPI, PS/2, Universal Serial Bus (USB), Bluetooth, RF, and IRDA.

In FIG. 1, the input device 100 is shown as a proximity sensor device (also often referred to as a “touchpad” or a “touch sensor device”) configured to sense input provided by one or more input objects 140 in a sensing region 120. Example input objects include fingers and styli, as shown in FIG. 1.

Sensing region 120 encompasses any space above, around, in and/or near the input device 100 in which the input device 100 is able to detect user input (e.g., user input provided by one or more input objects 140). The sizes, shapes, and locations of particular sensing regions may vary widely from embodiment to embodiment. In some embodiments, the sensing region 120 extends from a surface of the input device 100 in one or more directions into space until signal-to-noise ratios prevent sufficiently accurate object detection. The distance to which this sensing region 120 extends in a particular direction, in various embodiments, may be on the order of less than a millimeter, millimeters, centimeters, or more, and may vary significantly with the type of sensing technology used and the accuracy desired. Thus, some embodiments sense input that comprises no contact with any surfaces of the input device 100, contact with an input surface (e.g. a touch surface) of the input device 100, contact with an input surface of the input device 100 coupled with some amount of applied force or pressure, and/or a combination thereof. In various embodiments, input surfaces may be provided by surfaces of casings within which sensor electrodes reside, by face sheets applied over the sensor electrodes or any casings, etc. In some embodiments, the sensing region 120 has a rectangular shape when projected onto an input surface of the input device 100.

The input device 100 may utilize any combination of sensor components and sensing technologies to detect user input in the sensing region 120. The input device 100 comprises one or more sensing elements for detecting user input. As several non-limiting examples, the input device 100 may use capacitive, elastive, resistive, inductive, magnetic, acoustic, ultrasonic, and/or optical techniques.

Some implementations are configured to provide images that span one, two, three, or higher dimensional spaces. Some implementations are configured to provide projections of input along particular axes or planes.

In some resistive implementations of the input device 100, a flexible and conductive first layer is separated by one or more spacer elements from a conductive second layer. During operation, one or more voltage gradients are created across the layers. Pressing the flexible first layer may deflect it sufficiently to create electrical contact between the layers, resulting in voltage outputs reflective of the point(s) of contact between the layers. These voltage outputs may be used to determine positional information.

In some inductive implementations of the input device 100, one or more sensing elements pick up loop currents induced by a resonating coil or pair of coils. Some combination of the magnitude, phase, and frequency of the currents may then be used to determine positional information.

In some capacitive implementations of the input device 100, voltage or current is applied to create an electric field. Nearby input objects cause changes in the electric field, and produce detectable changes in capacitive coupling that may be detected as changes in voltage, current, or the like.

Some capacitive implementations utilize arrays or other regular or irregular patterns of capacitive sensing elements to create electric fields. In some capacitive implementations, separate sensing elements may be ohmically shorted together to form larger sensor electrodes. Some capacitive implementations utilize resistive sheets, which may be substantially uniformly resistive.

Some capacitive implementations utilize “self capacitance” (or “absolute capacitance”) sensing methods based on changes in the capacitive coupling between sensor electrodes and an input object. In various embodiments, an input object near the sensor electrodes alters the electric field near the sensor electrodes, thus changing the measured capacitive coupling. In one implementation, an absolute capacitance sensing method operates by modulating sensor electrodes with respect to a reference voltage (e.g. system ground), and by detecting the capacitive coupling between the sensor electrodes and input objects.

Some capacitive implementations utilize “mutual capacitance” (or “transcapacitance”) sensing methods based on changes in the capacitive coupling between sensor electrodes. In various embodiments, an input object near the sensor electrodes alters the electric field between the sensor electrodes, thus changing the measured capacitive coupling. In one implementation, a transcapacitive sensing method operates by detecting the capacitive coupling between one or more transmitter sensor electrodes (also “transmitter electrodes” or “transmitters”) and one or more receiver sensor electrodes (also “receiver electrodes” or “receivers”). Transmitter sensor electrodes may be modulated relative to a reference voltage (e.g., system ground) to transmit transmitter signals. Receiver sensor electrodes may be held substantially constant relative to the reference voltage to facilitate receipt of resulting signals. A resulting signal may comprise effect(s) corresponding to one or more transmitter signals, and/or to one or more sources of environmental interference (e.g. other electromagnetic signals). Sensor electrodes may be dedicated transmitters or receivers, or may be configured to both transmit and receive.

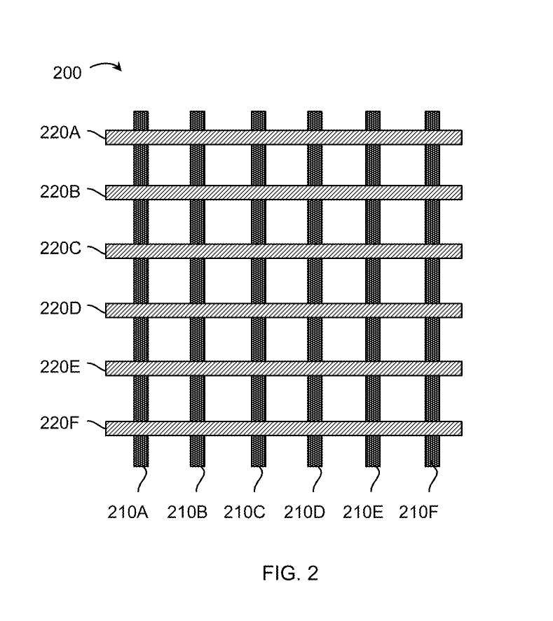

FIG. 2 illustrates, conceptually, an example set of capacitive sensor electrodes 200 configured to sense in a sensing region. For clarity of illustration and description, FIG. 2 shows a pattern of sensor electrodes arranged substantially perpendicular to each other, which may be referred to as an “image” sensor. It will be appreciated, however, that the invention is not so limited, and that a variety of electrode patterns and shapes may be suitable in any particular embodiment.

Sensor electrodes 210 and 220 of FIG. 2 are typically ohmically isolated from each other. In some embodiments, such sensor electrodes are separated from each by one or more substrates. For example, they may be disposed on opposite sides of the same substrate, or on different substrates that are laminated together.

In the embodiment depicted in FIG. 2, some sensor electrodes 210 (e.g., 210A, 210B, etc.) are configured as receiver electrodes, and some sensor electrodes 220 (e.g., 220A, 220B, etc.) are configured as transmitter electrodes. The capacitive coupling between the transmitter electrodes and receiver electrodes change with the proximity and motion of input objects in the sensing region associated with the transmitter electrodes and receiver electrodes. Sensor electrodes 210 might be disposed on a single layer of a substrate (either with or without jumpers), on multiple different substrates, or on different sides of the same substrate.

The receiver electrodes may be operated singly or multiply to acquire resulting signals. The resulting signals may be used to determine a “capacitive frame” representative of measurements of the capacitive couplings. Multiple capacitive frames may be acquired over multiple time periods, and differences between them used to derive information about input in the sensing region. For example, successive capacitive frames acquired over successive periods of time can be used to track the motion(s) of one or more input objects entering, exiting, and within the sensing region.

Referring again to FIG. 1, a processing system 110 is shown as part of the input device 100. The processing system 110 is configured to operate the hardware of the input device 100 (including, for example, the various sensor electrodes 200 of FIG. 2) to detect input in the sensing region 120. The processing system 110 comprises parts of or all of one or more integrated circuits (ICs) and/or other circuitry components. For example, as described in further detail below, a processing system for a mutual capacitance sensor device may comprise transmitter circuitry configured to transmit signals with transmitter sensor electrodes, and/or receiver circuitry configured to receive signals with receiver sensor electrodes).

In some embodiments, the processing system 110 also comprises electronically-readable instructions, such as firmware code, software code, and/or the like. In some embodiments, components composing the processing system 110 are located together, such as near sensing element(s) of the input device 100. In other embodiments, components of processing system 110 are physically separate with one or more components close to sensing element(s) of input device 100, and one or more components elsewhere. For example, the input device 100 may be a peripheral coupled to a desktop computer, and the processing system 110 may comprise software configured to run on a central processing unit of the desktop computer and one or more ICs (perhaps with associated firmware) separate from the central processing unit. As another example, the input device 100 may be physically integrated in a phone, and the processing system 110 may comprise circuits and firmware that are part of a main processor of the phone. In some embodiments, the processing system 110 is dedicated to implementing the input device 100. In other embodiments, the processing system 110 also performs other functions, such as operating display screens, driving haptic actuators, etc.

The processing system 110 may be implemented as a set of modules that handle different functions of the processing system 110. Each module may comprise circuitry that is a part of the processing system 110, firmware, software, or a combination thereof. In various embodiments, different combinations of modules may be used. Example modules include hardware operation modules for operating hardware such as sensor electrodes and display screens, data processing modules for processing data such as sensor signals and positional information, and reporting modules for reporting information. Further example modules include sensor operation modules configured to operate sensing element(s) to detect input, identification modules configured to identify gestures such as mode changing gestures, and mode changing modules for changing operation modes.

In some embodiments, the processing system 110 responds to user input (or lack of user input) in the sensing region 120 directly by causing one or more actions. Example actions include changing operation modes, as well as GUI actions such as cursor movement, selection, menu navigation, and other functions. In some embodiments, the processing system 110 provides information about the input (or lack of input) to some part of the electronic system (e.g. to a central processing system of the electronic system that is separate from the processing system 110, if such a separate central processing system exists). In some embodiments, some part of the electronic system processes information received from the processing system 110 to act on user input, such as to facilitate a full range of actions, including mode changing actions and GUI actions.

For example, in some embodiments, the processing system 110 operates the sensing element(s) of the input device 100 to produce electrical signals indicative of input (or lack of input) in the sensing region 120. The processing system 110 may perform any appropriate amount of processing on the electrical signals in producing the information provided to the electronic system. For example, the processing system 110 may digitize analog electrical signals obtained from the sensor electrodes. As another example, the processing system 110 may perform filtering or other signal conditioning. As yet another example, the processing system 110 may subtract or otherwise account for a baseline, such that the information reflects a difference between the electrical signals and the baseline. As yet further examples, the processing system 110 may determine positional information, recognize inputs as commands, recognize handwriting, and the like. In one embodiment, processing system 110 includes determination circuitry configured to determine positional information for an input device based on the measurement.

“Positional information” as used herein broadly encompasses absolute position, relative position, velocity, acceleration, and other types of spatial information. Example “zero-dimensional” positional information includes near/far or contact/no contact information. Example “one-dimensional” positional information includes positions along an axis. Example “two-dimensional” positional information includes motions in a plane. Example “three-dimensional” positional information includes instantaneous or average velocities in space. Further examples include other representations of spatial information. Historical data regarding one or more types of positional information may also be determined and/or stored, including, for example, historical data that tracks position, motion, or instantaneous velocity over time.

In some embodiments, the input device 100 is implemented with additional input components that are operated by the processing system 110 or by some other processing system. These additional input components may provide redundant functionality for input in the sensing region 120, or some other functionality. FIG. 1 shows buttons 130 near the sensing region 120 that can be used to facilitate selection of items using the input device 100. Other types of additional input components include sliders, balls, wheels, switches, and the like. Conversely, in some embodiments, the input device 100 may be implemented with no other input components.

In some embodiments, the input device 100 comprises a touch screen interface, and the sensing region 120 overlaps at least part of an active area of a display screen. For example, the input device 100 may comprise substantially transparent sensor electrodes overlaying the display screen and provide a touch screen interface for the associated electronic system. The display screen may be any type of dynamic display capable of displaying a visual interface to a user, and may include any type of light emitting diode (LED), organic LED (OLED), cathode ray tube (CRT), liquid crystal display (LCD), plasma, electroluminescence (EL), or other display technology. The input device 100 and the display screen may share physical elements. For example, some embodiments may utilize some of the same electrical components for displaying and sensing. As another example, the display screen may be operated in part or in total by the processing system 110.

It should be understood that while many embodiments of the invention are described in the context of a fully functioning apparatus, the mechanisms of the present invention are capable of being distributed as a program product (e.g., software) in a variety of forms. For example, the mechanisms of the present invention may be implemented and distributed as a software program on information bearing media that are readable by electronic processors (e.g., non-transitory computer-readable and/or recordable/writable information bearing media readable by the processing system 110). Additionally, the embodiments of the present invention apply equally regardless of the particular type of medium used to carry out the distribution. Examples of non-transitory, electronically readable media include various discs, memory sticks, memory cards, memory modules, and the like. Electronically readable media may be based on flash, optical, magnetic, holographic, or any other storage technology.

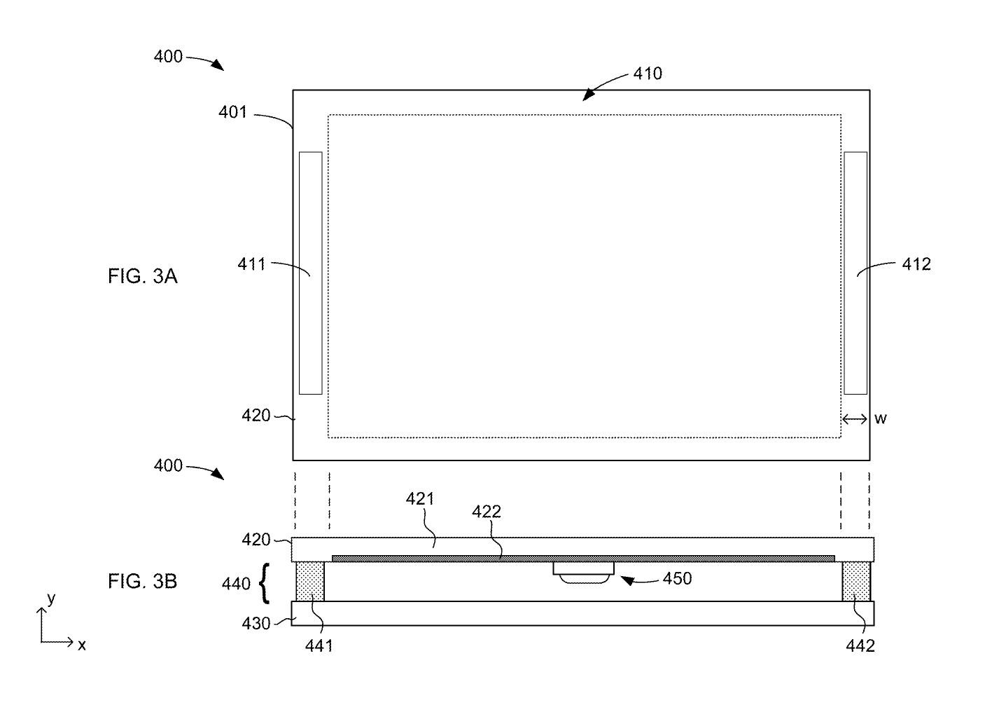

FIGS. 3A and 3B illustrate, respectively, a top view and a cross-sectional view of an example clickable input device (or simply “input device”) 400. In general, input device includes a capacitive sensing device 420, a support structure 430, a button component (or simply “button”) 450, and a separation device 440. As described in further detail below, separation device 440 is coupled to both support structure 430 and capacitive sensing device 420 and is configured to allow non-uniform displacement of capacitive sensing device 420 (relative to support structure 430) and to provide activation of button 450 in response to a force (not shown) applied to capacitive sensing device 420 by a user (e.g., via input object 140 of FIG. 1).

Capacitive sensing device 420 includes a plurality of sensor electrodes 422 (illustrated, for sake of simplicity, as a single contiguous region) disposed on a substrate 421. Sensor electrodes 422 may have any convenient configuration, such as the configuration illustrated in FIG. 2. Similarly, substrate 421 may comprise a variety of materials and structures. While FIG. 3B illustrates sensor electrodes 422 disposed on the underside of substrate 420 (i.e., relative to the orientation shown in the figure), the invention is not so limited. In one embodiment, for example, sensor electrodes 422 and substrate 421 are configured as a sensor-on-glass (SOG) device. In one embodiment, capacitive sensing device 420 is configured to sense changes in transcapacitance. In others, capacitive sensing device 420 is configured to sense changes in absolute capacitance.

Capacitive sensing device 420 has an edge region 410, which is indicated by the dotted line shown in FIG. 3A. As used herein, the phrase “edge region” refers to a region adjacent to the outer edge 401 of capacitive sensing device 420. Edge region 410 preferably has a width w that is significantly less than the lateral dimensions of capacitive sensing device 420. In the illustrated embodiment, for example, the width of edge region 410 is about one tenth of the entire x dimension of capacitive sensing device 420. In other embodiments, the width of edge region 410 is between about 1/100 and ⅕ of the greatest lateral dimension of capacitive sensing device 420 (e.g., in the case of a rectangular sensing device, the length of the diagonal dimension). In other embodiments, the area (as seen in top view) of edge region 410 is about 1% to 10% of the entire area of capacitive sensing device 420. In one embodiment, edge region 410 is the outer 3 mm of a device having a lateral dimension of about 100 mm. In other embodiments, the edge region extends beyond the perimeter 401.

Button 450 may comprise any suitable button mechanism known in the art, and may be located in any convenient location. In the illustrated embodiment, button 450 is illustrated as coupled to sensor electrodes 422. In other embodiments, button 450 is coupled to support structure 430. Regardless of structure, button 450 is configured to be activated when a sufficient force (e.g., downward force) is applied to capacitive sensing device 420.

Separation device 440 comprises at least two flexure mechanisms: flexure mechanism 441 and flexure mechanism 442, which in the interest of simplicity are illustrated conceptually (and without loss of generality) as rectangular structures. Flexure mechanism 441 is coupled to one portion 411 of edge region 410, while flexure mechanism 412 is coupled to another portion 412 of edge region 410. Portion 411 is remote from portion 412 at least in the sense that portions 411 and 412 do not overlap. In some embodiments, portions 411 and 412 are on substantially opposite sides of capacitive sensing device 420—i.e., antipodal. As detailed in further detail below, the flexure mechanisms and respective edge region portions may have a variety of configurations.

In one embodiment, flexure mechanism 441 (and/or flexure mechanism 442) is coupled to and extends from substrate 421. In other embodiments, flexure mechanism 441 is coupled to and extends from support structure 430. In general, flexure mechanisms 441 and 442 may be coupled to support structure 430 and capacitive sensing device 420 in a variety of ways, including slideably coupled, rotateably coupled, rigidly coupled, etc. Similarly, flexure mechanisms 441 may exhibit a variety of shapes and be formed from a variety of materials, including various plastics, metals, and composites.

Regardless of coupling method or material, flexure mechanisms 441 and 442 cooperate to allow non-uniform displacement of capacitive sensing device 420 and activation of button 450 in response to a force applied to capacitive sensing device 420. As used herein with respect to capacitive sensing device 420 the phrase “non-uniform displacement” means movement of capacitive sensing device 420 with respect to support structure 430 in a way that includes a rotational component, not just a translational component. Stated another way, capacitive sensing device 420 is not constrained in a way forces it to remain substantially parallel to support structure 430 as it moves.

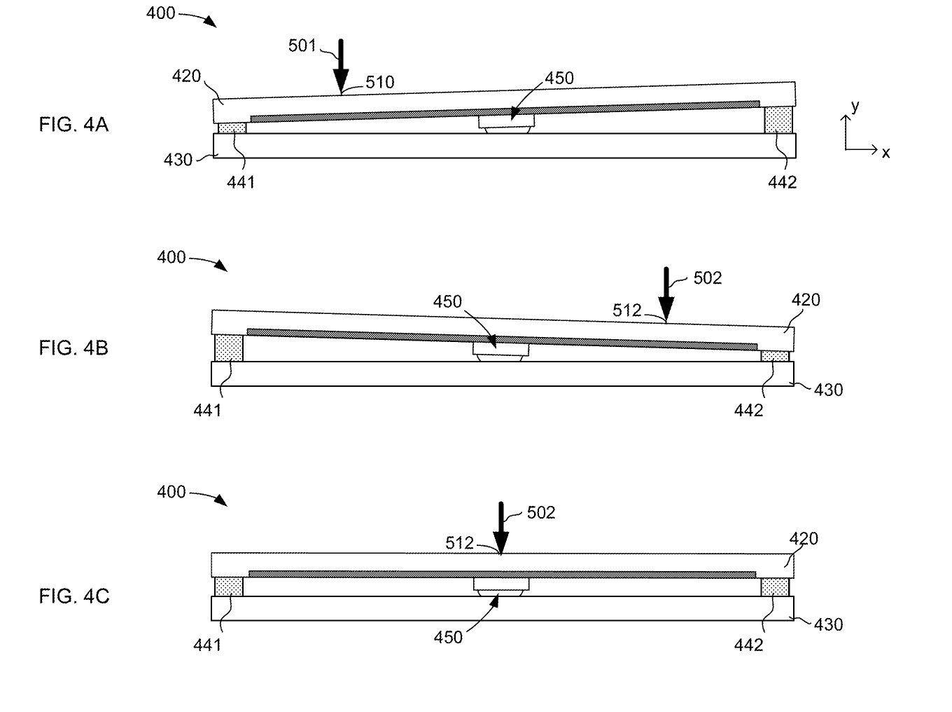

FIG. 4A illustrates non-uniform displacement of clickable input device 400 as it is subjected to a downward force 501 (i.e., a force parallel to the negative y-axis) applied at a point 510. In this embodiment, capacitive sensing device 420 “tilts” toward flexure mechanism 441 (shown as counterclockwise rotation combined with translation in the negative y direction) because point 510 of force 501 is closer to flexure mechanism 441 than flexure mechanism 442. The opposite response is shown in FIG. 4B, in which force 501 is applied closer to flexure mechanism 442 than flexure mechanism 441. In general, then, FIGS. 4A-54 together depict what may be termed a “see-saw” behavior—i.e., greater deformation of a first flexure mechanism than a second flexure mechanism when the force is applied closer to the first flexure mechanism than the second flexure mechanism (FIGS. 4A and 4B), and substantially equal deformation of the first flexure mechanism and the second flexure mechanism when the force is applied equidistant from the first flexure mechanism and the second flexure mechanism (FIG. 4C). The invention is not limited to this “see-saw” behavior, however: the flexure mechanisms may be positioned to provide any suitable response to a force.

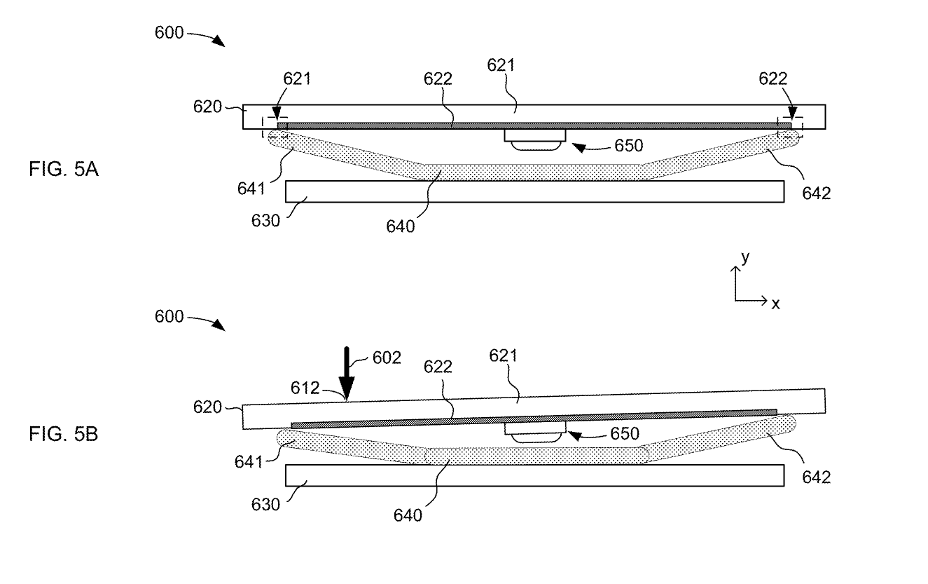

FIGS. 5A and 5B depict operation of an example input device 600 comprising a capacitive sensing device 620 (including a plurality of sensor electrodes 622 and substrate 621), a support structure 630, and a separation device 640. Separation device 640 is coupled to support structure 630 and includes a pair of flexure mechanisms 641 and 642 extending outward and coupling to capacitive sensing device 620 at portions 621 and 622, respectively, of a corresponding edge region (not illustrated). Flexure mechanisms 641 and 642 are formed from a suitably elastic material (e.g., plastic, metal, or other materials) and are configured to bend or otherwise deform, as shown in FIG. 5B, when a force 602 is applied to a point 612 on capacitive sensing device 620. In one embodiment, separation device 640 is a single contiguous unit. It can be seen that FIGS. 5A and 5B provide an alternate configuration for achieving the “see-saw” behavior previously depicted in FIGS. 5A-5C.

While flexure mechanisms 641 and 642 are illustrated as extending outward from a central region of separation device 640 (i.e., oriented so that they generally extend left and right, respectively, in relation to the figure), flexure mechanisms 641 and 642 may be positioned in any number of ways with respect to capacitive sensing device 620 and support structure 630. For example, both flexure mechanisms 641 and 642 may configured such that they have the same general orientation—e.g., both extending to the right in relation to the figure.

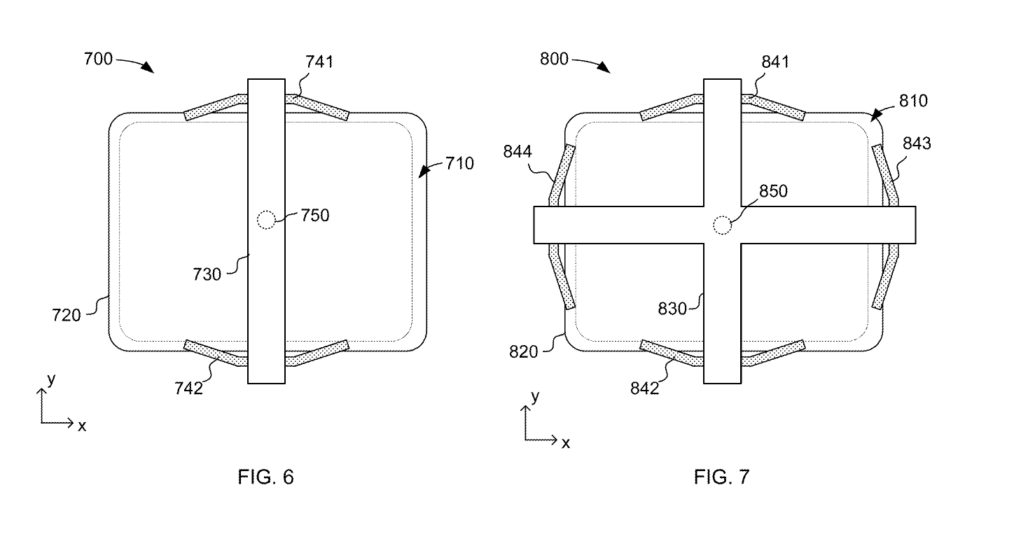

As mentioned above, embodiments in accordance with the present invention may include any number of flexure mechanisms provided in a variety of geometrical configurations. In some embodiments, the flexure mechanisms are distributed such that they exhibit symmetry with respect to the capacitive sensing device—e.g., rotational symmetry or reflexional symmetry. In this regard, FIGS. 6-8 present three such examples in which additional flexure mechanisms are provided to allow for more uniform response and to accommodate the use of larger touchpads.

In FIG. 6, input device 700 includes a capacitive sensing device 720 having an edge region 710, a button 750, and a support structure 730 coupled to flexure mechanisms 741 and 742. In this embodiment, support structure 730 is a generally rectangular structure having a major axis parallel to the y-axis and having a surface area that is much smaller than that of capacitive sensing device 720. Flexure mechanisms 741 and 742 are positioned at opposite ends of support structure 730.

In FIG. 7, input device 800 includes a capacitive sensing device 820 having an edge region 810, a button 850, and a support structure 830 coupled to flexure mechanisms 841, 842, 843, and 844. In this embodiment, support structure 830 is a generally cross-shape structure having rectangular regions extending parallel to both the x and y axes. As with the embodiment shown in FIG. 6, support structure 830 has a surface area that is much smaller than that of capacitive sensing device 820. Flexure mechanisms 841, 842, 843, and 844 are positioned to respectively support each of the four sides of capacitive sensing device 820.

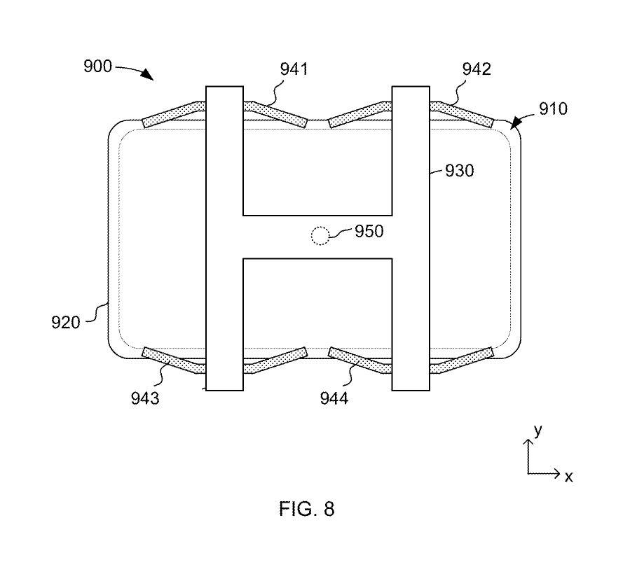

In FIG. 8, input device 900 includes a capacitive sensing device 920 having an edge region 910, a button 950, and a support structure 930 coupled to flexure mechanisms 941, 942, 943, and 944. In this embodiment, support structure 930 is a generally H-shaped and has a surface area that is much smaller than that of capacitive sensing device 820. Flexure mechanisms 941 and 942 are used to support one side of capacitive sensing device 920, and flexure mechanisms 943 and 943 are used to support the opposite side.

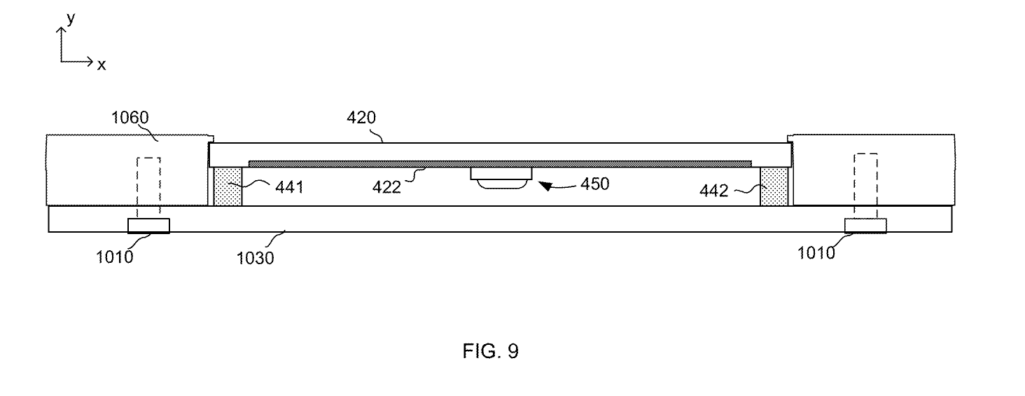

The support structures used in the various embodiments described above may have any suitable shape and may comprise a variety of materials. That is, while FIGS. 6-8 depict support structures that are generally rectangular, cross-shaped, or “H”-shaped, other shapes (such as “T”-shaped and the like) may be used. In one embodiment, as depicted in FIG. 9, support structure 1030 comprises a bracket configured to removeably attach (e.g., via attachment components 1010) to a palm rest 1060 of an electronic system. In other embodiments, support structure 1030 is configured to be coupled to a housing of an electronic device. In some embodiments, the substrate of the capacitive sensing device has an area that is greater than that of the support structure. Such embodiments are shown, for example, in FIGS. 6-8. In other embodiments, the support structure has a surface area that is substantially equal or slightly greater than that of the substrate.

Thus, the embodiments and examples set forth herein were presented in order to best explain the present invention and its particular application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed.

What is claimed is:

1. An input device comprising:
a capacitive sensing device comprising a plurality of sensor electrodes disposed on a substrate, the capacitive sensing device having an edge region;
a support structure; and
a separation device coupled to the support structure and the capacitive sensing device;
wherein the separation device is configured to allow non-uniform displacement of the capacitive sensing device and activation of a button in response to a force applied to the capacitive sensing device by a user, the separation device comprising:
a first flexure mechanism coupled to a first portion of the edge region of the capacitive sensing device, and
a second flexure mechanism coupled to a second portion of the edge region of the capacitive sensing device, the first portion being remote from the second portion.

2. The input device of claim 1, wherein the first portion of the edge region is substantially antipodal to the second portion of the edge region.

3. The input device of claim 1, wherein the displacement of the capacitive sensing device includes:
greater deformation of the first flexure mechanism than the second flexure mechanism when the force is applied closer to the first flexure mechanism than the second flexure mechanism; and
substantially equal deformation of the first flexure mechanism and the second flexure mechanism when the force is applied equidistant from the first flexure mechanism and the second flexure mechanism.

4. The input device of claim 1, wherein the support structure comprises a bracket configured to removeably attach to a housing of an electronic device.

5. The input device of claim 1, wherein the support structure has a first surface area, and the substrate has a second surface area that is greater than the first surface area.

6. The input device of claim 1, wherein the capacitive sensing device is configured to sense changes in transcapacitance.

7. The input device of claim 1, wherein the capacitive sensing device is configured to sense changes in absolute capacitance.

8. The input device of claim 1, wherein the first flexure mechanism is coupled to and extends from the substrate.

9. The input device of claim 1, wherein the first flexure mechanism is coupled to and extends from the support structure.

10. The input device of claim 1, wherein the support structure is configured to be coupled to a palm rest of an electronic system.

11. The input device of claim 1, further including one or more additional flexure mechanisms, wherein the first flexure mechanism, the second flexure mechanism, and the one or more additional flexure mechanisms are positioned symmetrically with respect to the edge region of the capacitive sensing device.

12. The input device of claim 1, wherein the plurality of sensor electrodes and the substrate of the capacitive sensing device are configured as a sensor-on-glass device.

13. A separation device configured to be positioned between a support structure and a capacitive sensing device of an input device having a button component provided therein, the separation device comprising:
a first flexure mechanism coupled to a first portion of an edge region of the capacitive sensing device, and
a second flexure mechanism coupled to a second portion of the edge region of the capacitive sensing device, the first portion being remote from the second portion;
wherein the first flexure mechanism and second flexure mechanism are configured to allow non-uniform displacement of the capacitive sensing device and activation of the button component in response to a force applied to the capacitive sensing device by a user.

14. The separation device of claim 13, wherein the first portion of the edge region is substantially antipodal to the second portion of the edge region.

15. The separation device of claim 13, wherein the first and second flexure mechanisms together provide greater deformation of the first flexure mechanism than the second flexure mechanism when the force is applied closer to the first flexure mechanism than the second flexure mechanism, and substantially equal deformation of the first flexure mechanism and the second flexure mechanism when the force is applied equidistant from the first flexure mechanism and the second flexure mechanism.

16. The separation device of claim 13, wherein the first flexure mechanism is coupled to and extends from the substrate.

17. The separation device of claim 13, wherein the first flexure mechanism is coupled to and extends from the support structure.

18. An electronic system comprising:
a housing;
a capacitive sensing device comprising a plurality of sensor electrodes disposed on a substrate, the capacitive sensing device having an edge region;
a support structure coupled to the housing; and
a separation device coupled to the support structure and the capacitive sensing device;
wherein the separation device is configured to allow non-uniform displacement of the capacitive sensing device and activation of a button in response to a force applied to the capacitive sensing device by a user, the separation device comprising:
a first flexure mechanism coupled to a first portion of the edge region of the capacitive sensing device, and
a second flexure mechanism coupled to a second portion of the edge region of the capacitive sensing device, the first portion being remote from the second portion.

19. The electronic system of claim 18, wherein the displacement of the capacitive sensing device includes:
greater deformation of the first flexure mechanism than the second flexure mechanism when the force is applied closer to the first flexure mechanism than the second flexure mechanism; and
substantially equal deformation of the first flexure mechanism and the second flexure mechanism when the force is applied equidistant from the first flexure mechanism and the second flexure mechanism.

20. The electronic system of claim 18, wherein the plurality of sensor electrodes and the substrate of the capacitive sensing device are configured as a sensor-on-glass device.
